(19) United States
(12) Patent Application Publication
(10) Pub. No.: US 2007/0190944 A1
(43) Pub. Date: Aug. 16, 2007

(54) Method and system for automatic presence and ambient noise detection for a wireless communication device

(76) Inventors: Christopher Hoang Doan, Austin, TX (US); Lee Saenz, Austin, TX (US); Shaw-Ben Shi, Austin, TX (US)

Correspondence Address: IBM CORP (YA);C/O YEE & ASSOCIATES PC, P.O. BOX 802333, DALLAS, TX, 75380, US

(21) Appl. No.: 11/352,761

(22) Filed: Feb. 13, 2006

(51) Int. Cl. H04B 1/00; H04B 15/00

(52) U.S. Cl. 455/63.1

(57) ABSTRACT

A system for automatic presence and ambient noise detection for a client device. An incoming message from a caller is received and in response to receiving the incoming message from the caller, a client device state is detected based on a callee situation as dynamically detected by using the client device. After detecting the client device state, the incoming message is converted according to a rule set. The converted incoming message is then rendered on the client device differently than the incoming message would have been by the client device.

### BACKGROUND OF THE INVENTION

1. Field of the Invention

The present invention relates generally to an improved data processing system. More specifically, the present invention is directed to a computer implemented method, apparatus, and computer usable program code for automatic presence and ambient noise detection for a wireless communication device.

2. Description of the Related Art

A wireless communication device (WCD) is of great importance in today's increasingly mobile society. Productivity and efficiency levels are increased by the use of wireless communication devices because people are able communicate on an almost instantaneous basis. As technology progresses and the ability to miniaturize circuitry increases, the cost of implementing this new technology decreases. This phenomenon creates a great opportunity for wireless communication devices to comprise more useful features. Indeed, many advanced features are now available on wireless communication devices, which set the landscape for the integration of additional useful and novel features.

For example, the ability to use and integrate voice recognition software into applications and components of wireless communication devices, such as word processing, memos, translation of telephone conversations from voice-to-text, and many other similar applications is very useful. Voice recognition software may allow, for example, a deaf person to participate in a telephone conversation by providing the deaf person with the text of the caller's spoken words on a display screen of the deaf person's wireless communication device. Conversely, the ability to convert a text message into a voice message by a text-to-voice converter in communication systems is also very useful.

Further, current presence systems provide basic information to network clients concerning the presence status of related users, such as those on the network clients' buddy list. The term presence in the context of instant messaging is a state of knowing that another person is currently online and available. In its ultimate implementation, presence may mean that people may be located no matter where they are so that an instant message, e-mail, or voice message may be immediately delivered to them.

Even in internet protocol (IP) telephone networks, presence status is typically determined using relatively basic presence indications. These basic presence indications include, for example, detection of whether the user is logged on, detection of keyboard activity, detection of whether a desk phone is in use or in a do-not-disturb mode, detection of instant messaging activity, or detection of a manual presence setting.

Moreover, a global position system (GPS) receiving unit may be contained within a wireless communication device to identify the location of the wireless communication device. GPS is a radio navigation system run by the Department of Defense. By triangulation of signals from three of the twenty-four GPS satellites, a GPS receiving unit contained within the wireless communications device may pinpoint the wireless communication device's current location anywhere on earth.

Also, a user of a current wireless communication device may manually set the state of the wireless communication device. For example, the user may manually set the wireless communication device ring style state to silent by pressing buttons on the wireless communication device when preparing to enter a theater performance. Additionally, the user may manually set a call forwarding to voicemail state while in the theater performance as well.

Therefore, it would be beneficial to have a computer implemented method, apparatus, and computer usable program code for automatic presence and ambient noise detection for a wireless communication device.

### SUMMARY OF THE INVENTION

Embodiments of the present invention provide a computer implemented method, apparatus, and computer usable program code for automatic presence and ambient noise detection for a client device. An incoming message from a caller is received. In response to receiving the incoming message from the caller, a client device state is detected based on a callee situation as dynamically detected by using the client device. Subsequent to detecting the client device state, the incoming message is converted according to a rule set to form a converted incoming message. The converted incoming message is then rendered on the client device differently than the incoming message would have been by the client device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is an exemplary block diagram of presence server components in accordance with embodiments of the present invention;

FIG. 4A is an exemplary pictorial representation of a wireless communication device in accordance with an embodiment of the present invention;

FIG. 4B is an exemplary block diagram illustrating the hardware configuration of a wireless communication device in accordance with an embodiment of the present invention;

FIG. 5 is a flowchart illustrating an exemplary process for message conversion in a presence server in accordance with an embodiment of the present invention;

FIG. 6 is a flowchart illustrating an exemplary process for presence and ambient noise detection in a wireless communication device in accordance with an embodiment of the present invention;

FIG. 7 is a flowchart illustrating an exemplary process for automatically setting states in a wireless communication device using an intelligent mode unit in accordance with an embodiment of the present invention;

FIG. 8 is a flowchart illustrating an exemplary process for determining presence in a wireless communication device using a presence unit in accordance with an embodiment of the present invention;

FIG. 9 is a flowchart illustrating an exemplary process for determining ambient noise levels surrounding a wireless communication device using an ambient noise detector in accordance with an embodiment of the present invention; and

FIG. 10 is an exemplary set of rules for message conversion in a presence server in accordance with embodiments of the present invention.

### DETAILED DESCRIPTION OF THE PREFERRED EMBODIMENT

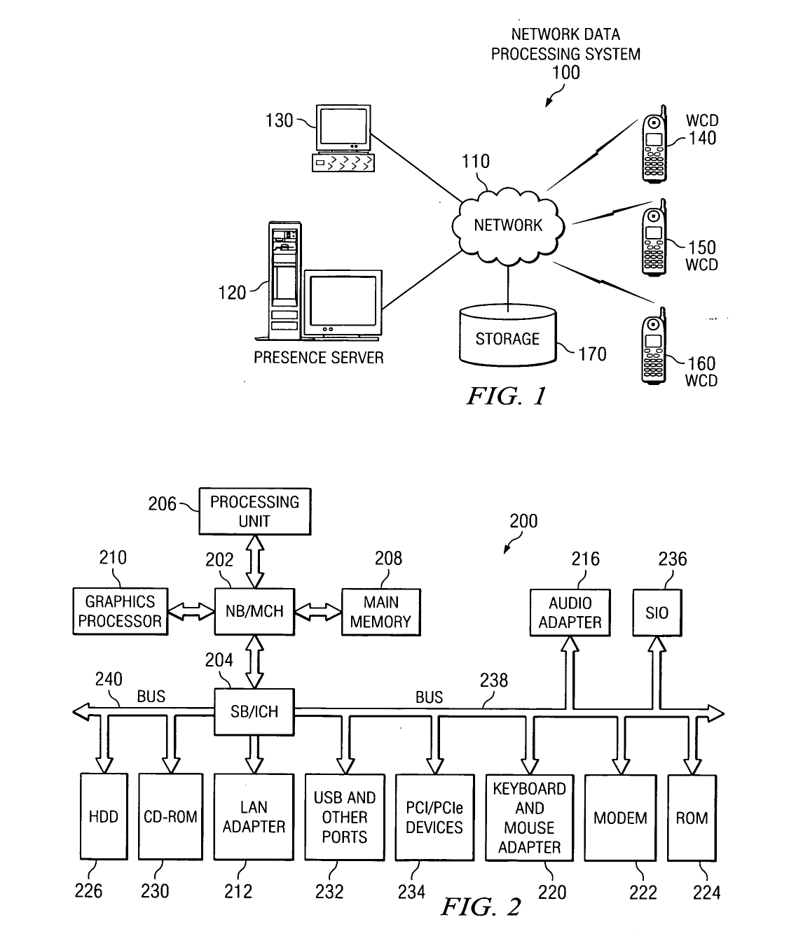

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 110, which is the medium used to provide communications links between various devices and computers connected together within network data processing system 100. Network 110 may include several types of connections, such as wire, wireless communication links, or fiber optic cables. However, for the purposes of the present invention, wireless communication links will be emphasized.

In the depicted example, server 120 is connected to network 110. Server 120 may be, for example, a presence server with high speed connections to network 110. In an embodiment of the present invention, presence server 120 may be, for example, located within a cellular telephone service provider network. In another embodiment of the present invention, presence server 120 may, for example, independently provide automatic presence and message conversion services for a plurality of cellular telephone service provider networks.

Clients 130, 140, 150, and 160, along with storage unit 170, also are connected to network 110. Additionally, clients 130, 140, 150, and 160 are clients to presence server 120. Client 130 is a personal computer using a conventional land line communication link. Clients 140, 150, and 160 are wireless communication devices relying on wireless communication links. The wireless communication devices may be, for example, cellular telephones, personal digital assistants, handheld computers, laptop computers, personal computers or any combination thereof. In addition, the wireless communication devices are not restricted to the above list of devices. The wireless communication devices may be any devices capable of wireless communication.

Further, network data processing system 100 may include, for example, additional servers, clients, storage units, and other devices not shown. In this illustrated example, network data processing system 100 is the Internet with network 110 representing a worldwide collection of networks and gateways that use the transmission control protocol/internet protocol (TCP/IP) suite of protocols to communicate with one another. At the heart of the Internet is a backbone of high-speed data communication lines between major nodes or host computers, consisting of thousands of commercial, government, educational and other computer systems that route data and messages. FIG. 1 is intended only as an exemplary illustration and is not intended as an architectural limitation for embodiments of the present invention.

Referring now to FIG. 2, a block diagram of a data processing system is shown in which aspects of the present invention may be implemented. Data processing system 200 is an example of a computer, such as presence server 120, personal computer 130, or client 140 in FIG. 1, in which computer usable program code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or the LINUX operating system (eServer, pSeries, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes for embodiments of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Presently, no system or device exists for automatically determining whether a wireless communication device is moving and at what speed. In addition, if the wireless communication device is moving, no current system or device automatically converts an incoming text message into a voice message for the user's convenience and safety. Also, no current system or device automatically converts the ring style state to vibrate and/or lights if the ambient noise level surrounding the wireless communication device is “too loud.” Further, no current system automatically converts incoming voice messages from a caller into text messages if ambient noise levels are “too high” for a wireless communication device user to properly hear the caller.

Aspects of the present invention provide a computer implemented method, apparatus, and computer usable program code for automatic presence and ambient noise detection for a wireless communication device. An incoming message from a caller is received and in response to receiving the incoming message, a client device state is detected based on a callee situation as dynamically detected by using the client device. The client device is a wireless communication device, such as, for example, a cellular telephone. The client device state may be, for example, normal, moving, and/or noisy.

The callee is the user of the client device that will receive the call or message from the caller. In the context of this application, callee situation means the situation that the user of the client device is in at the time an incoming message or call is detected by the client device and/or a presence server. The callee situation may be, for example, that the callee is in a noisy environment, such as a football stadium during a playoff game, a loud meeting room, a loud party, a construction area, an industrial environment, and the like. Or, the callee situation may be, for example, that the callee is in motion, such as driving an automobile, riding a bicycle, jogging, and the like. The client device, and/or the presence server monitoring the client device, dynamically determines the callee situation and automatically sets the client device state accordingly.

After detecting the client device state, the incoming message is converted according to a message conversion rule set. An example of a message conversion rule may be to convert an incoming text message to a voice message if the client device state is detected as moving. Conversion of the incoming message may be accomplished, for example, by the presence server or the client device. The converted incoming message is then rendered on the client device differently than the incoming message would have been by the client device. In addition, any response message from the client device is converted according to the message conversion rule set and then sent to the caller. Conversion of the response message may also be accomplished, for example, by the presence server or the client device.

A benefit of embodiments of the present invention may be that a wireless communication device that is moving may automatically detect the wireless communication device's presence or movement. This automatic presence detection allows the wireless communication device to determine when incoming and outgoing message conversion is needed. For example, receiving a text message on a wireless communication device while driving may prove dangerous, especially if the driver tries to read and respond to the text message while in heavy traffic. The processes used by embodiment of the present invention automatically convert text-to-voice and voice-to-text for the purpose of allowing a user of a wireless communication device to respond to an incoming message while continuing with an activity, such as driving, for convenience and safety of the user.

Another benefit of embodiments of the present invention may be that when ambient noise levels surrounding the wireless communication device are determined to be “too high” by an ambient noise detector contained within the wireless communication device, embodiments of the present invention automatically convert incoming voice messages into text messages for the user's convenience. In addition, when the ambient noise levels are determined to be “too high” by the ambient noise detector, embodiments of the present invention may automatically enable a vibrate and/or lights ring style in order to allow the user a greater opportunity to receive the call in a noisy environment.

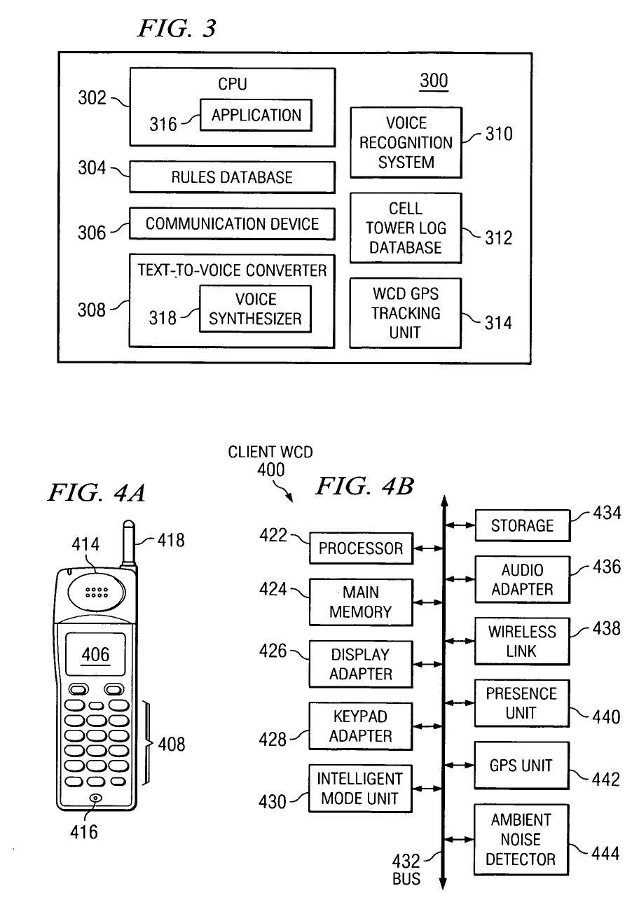

Turning now to FIG. 3, an exemplary block diagram of presence server components is depicted in accordance with embodiments of the present invention. Presence server 300 may be, for example, presence server 120 in FIG. 1. Presence server 300 may contain components, such as central processing unit (CPU) 302, rules database 304, communication device 306, text-to-voice converter 308, voice recognition system 310, cell tower log database 312, and wireless communication device global positioning system tracking unit 314.

Embodiments of the present invention may utilize presence server 300 to provide automatic presence information, as well as, message conversion services to a plurality of wireless communication devices that are in communication with presence server 300, such as wireless communication devices 140, 150, and 160 in FIG. 1. Central processing unit 302, such as, for example, processing unit 206 in FIG. 2, provides the processing capabilities of presence server 300. Application 316 may reside in central processing unit 302 and provide the computer usable program code for embodiments of the present invention to function in presence server 300.

Rule database 304 contains a set of rules whereby presence server 300 performs message conversion services for the plurality of client wireless communication devices. For example, rule database 304 may contain a rule which states that a caller will receive a responding message, whether in text or in voice, back in the same format as originally sent. By way of exemplary illustration, if the caller originally sent a text message to a client wireless communication device, but the user of the wireless communication device responds to the text message by voice, presence server 300 converts the user's voice response to a text message before sending the user's response back to the caller. An exception to that rule may be, for example, if the caller utilizes an embodiment of the present invention as well, presence server 300 sends the response back to the caller according to the rest of the rule set contained within rules database 304. However, embodiments of the present invention are restricted to the above mentioned exemplary rules. Any rules may be developed for and utilized by embodiments of the present invention to accomplish the processes of the present invention.

Communication unit 306 provides communication functions for presence server 300 and may include, for example, one or more devices to transmit and receive messages, such as modem 222 and network adapter 212 of FIG. 2. Presence server 300 uses text-to-voice converter 308 to convert text messages to voice messages when application 316 directs text-to-voice converter 308 to convert text messages according to the set of rules contained in rules database 304. Text-to-voice converter 308 uses voice synthesizer 318 to assist in accomplishing this task. Presence server 300 utilizes voice recognition system 310 to convert voice messages into text messages when application 316 directs voice recognition system 310 to convert voice messages according to the set of rules contained in rules database 304.

Those of ordinary skill in the art will appreciate that the term voice message may include, for example, normal telephone voice conversation, burst mode walkie-talkie conversation, voice over IP conversation, or any other form of conversation capable of being used by embodiments of the present invention. Also, those of ordinary skill in the art will appreciate that the term text message may include, for example, standard e-mail, instant messaging (IM), short message service (SMS), or any other form of text message capable of being used by embodiments of the present invention. Further, it should be noted that all message conversion by the presence server is performed in real-time or with only a slight delay.

Cell tower log database 312 stores records of cell tower usage by the plurality of client wireless communication devices. Application 316 may use these cell tower records, for example, to determine a client wireless communication device's presence or movements. In the context of this specification, presence is the ability to determine the location of the wireless communication device, compare the present location to previous locations over a predetermined period of time, and then calculate the wireless communication device rate of movement.

Wireless communication device global positioning system tracking unit 314 may, for example, monitor and record global positioning system (GPS) unit information for the plurality of wireless communication devices containing such a unit. Furthermore, application 316 may also use the wireless communication device global positioning system records to determine presence for the plurality of client wireless communication devices. This wireless communication device global positioning system information may be used in conjunction with, or instead of, the cell tower log information to determine presence.

With reference now to FIG. 4A, an exemplary pictorial representation of a wireless communication device is depicted in accordance with an embodiment of the present invention. In this illustrative example, client wireless communication device 400 is a cellular telephone. However, any wireless communication device may be used by embodiments of the present invention. Client wireless communication device 400 may be, for example, client wireless communication device 140 in FIG. 1.

Client wireless communication device 400 may include, for example, display 406 for presenting textual and graphical information. Display 406 may be a known display device, such as a liquid crystal display (LCD). Client wireless communication device 400 may also include, for example, keypad 408, speaker 414, and microphone 416. Keypad 408 may be utilized, for example, to enter user identification information, commands for interacting with the interface, and telephone numbers. Audio feedback may be presented via speaker 414. Microphone 416 may be used not only for voice conversation, but also for entering specific voice commands for voice actuated functions. Client wireless communication device 400 also includes antenna 418, which is necessary for establishing wireless communication links with a network, such as, for example, network 110 in FIG. 1.

Referring now to FIG. 4B, an exemplary block diagram illustrating the hardware configuration of a wireless communication device in accordance with an embodiment of the present invention is depicted. FIG. 4B illustrates the increasing sophistication of modern wireless communication device designs.

Client wireless communication device 400 utilizes bus architecture. Processor 422 and main memory 424 are connected to bus 432. Display adapter 426, keypad adapter 428, intelligent mode unit 430, storage 434, audio adapter 436, presence unit 440, global positioning system unit 442, and ambient noise detector 444 are also connected to bus 432.

In addition, client wireless communication device 400 includes wireless link 438 connected to bus 432. Wireless link 438 may be, for example, radio, microwave, shortwave, wireless fidelity (Wi-Fi), Bluetooth, and the like. Intelligent mode unit 430 may be utilized, for example, to enable, monitor, and disable other functions within the wireless communication device, such as presence, ambient noise detection, ring style, and speaker phone. However, it should be noted that in other embodiments of the present invention presence and ambient noise detection functions may be enabled and disabled independently of each other and independently of the intelligent mode unit.

Presence unit 440 may determine presence of the wireless communication device by, for example, monitoring cell tower log information stored in main memory 424. Alternatively, presence unit 440 may monitor the cellular telephone service provider's cell tower logs stored within a storage unit, such as storage unit 170 in FIG. 1 or within a cell tower log database located within the presence server, such as cell tower log database 312 in FIG. 3 to determine presence. Or, presence unit 440 may monitor global positioning system unit 442 for position information of the wireless communication device to determine presence. Or, presence unit 440 may, for example, wirelessly communicate with a vehicle's instrumentation, such as an accelerometer to determine motion and speed of the wireless communication device.

Ambient noise detector 444 may, for example, continuously monitor the wireless communication device's microphone, such as microphone 416 in FIG. 4A. Alternatively, ambient noise detector 444 may only monitor the microphone during a specified event, such as, for example, detection of an incoming call or message by the wireless communication device. Ambient noise detector 444 monitors the microphone for ambient noise. Ambient noise detection, in the context of this specification, is the ability to detect and monitor the noise levels surrounding the wireless communication device at all times or only during specified events.

Those of ordinary skill in the art will appreciate that the hardware in FIG. 4B may vary depending on the implementation. Other internal hardware or peripheral devices may be used in addition to or in place of the hardware depicted in FIG. 4B. For example, wireless communication device 400 may also include a text-to-voice converter and a voice recognition system in order to perform message conversion itself.

Client wireless communication device 400 may rely on wireless application protocol (WAP) for facilitating communications. Wireless application protocol is a standard for providing wireless phones, pagers and other handheld devices with secure access to e-mail and text-based Web pages. Wireless application protocol provides a complete environment for wireless applications that includes a wireless counterpart of TCP/IP and a framework for telephony integration such as call control and phone book access. Wireless application protocol features the wireless markup language (WML), which was derived from Phone.com's handheld device markup language (HDML) and is a streamlined version of hypertext markup language (HTML) for small screen displays. Also, wireless application protocol uses WMLScript, a compact JavaScript-like language that runs in limited memory. Additionally, wireless application protocol supports handheld input methods such as keypad and voice recognition.

Wireless application protocol runs over all the major wireless networks now in place. Also, wireless application protocol is device independent, requiring only a minimum functionality in the unit so that it can be used with a myriad of cellular phones and handheld devices. However, it should be pointed out that wireless application protocol has been described for illustrative purposes, and other wireless protocols may be used to implement the present invention.

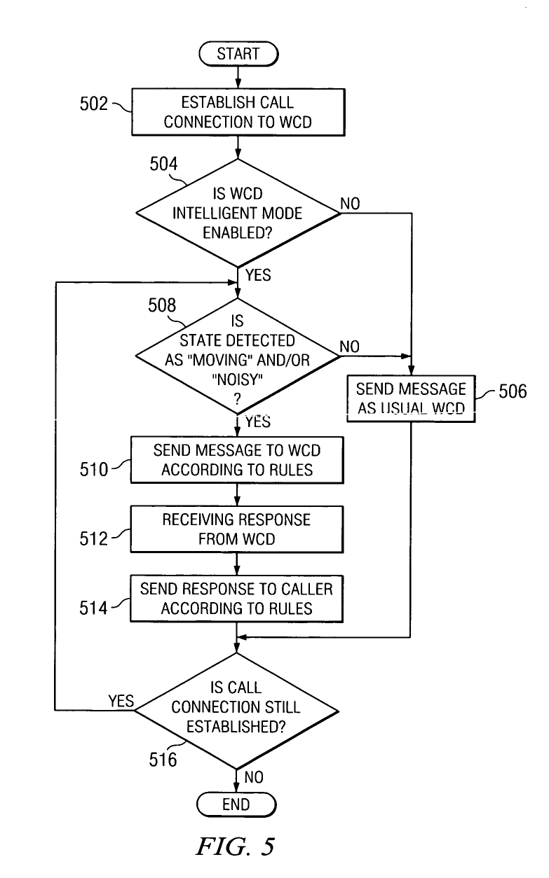

Turning now to FIG. 5, a flowchart is depicted illustrating an exemplary process for message conversion in a presence server in accordance with an embodiment of the present invention. The process depicted in FIG. 5 may be implemented, for example, in a presence server, such as presence server 300 in FIG. 3.

The process begins when a presence server establishes a call connection to a client wireless communication device, such as client wireless communication device 140 in FIG. 1 (step 502). Subsequent to establishing the call connection in step 502, the presence server determines whether a user enabled a wireless communication device intelligent mode unit, such as intelligent mode unit 430 in FIG. 4 (step 504). If the wireless communication device intelligent mode unit is not enabled, no output of step 504, then the presence server sends the incoming message from a caller to the wireless communication device as usual during normal operation (step 506). The process proceeds to step 516 thereafter.

It should be noted that the presence server renders the incoming message for display on the wireless communication device display screen, such as display 406 in FIG. 4. Rendering, in the context of this specification, means to convert any coded content to a required format for display. Alternatively, in another embodiment of the present invention, the wireless communication device may render the incoming message for display on the wireless communication device's display screen itself.

If the wireless communication device intelligent mode unit is enabled, yes output of step 504, then the presence server makes a determination as to whether the wireless communication device state is detected as moving and/or “noisy” (step 508). If the wireless communication device state is not detected as “moving” and/or “noisy,” no output of step 508, then the process returns to step 506 where normal operation continues. If the wireless communication device state is detected as “moving” and/or “noisy,” yes output of step 508, then the presence server sends the incoming message to the wireless communication device in accordance with a set of rules governing message conversion, such as, for example, the message conversion rule set contained within rules database 304 in FIG. 3 (step 510).

After the presence server sends the incoming message to the wireless communication device according to the set of message conversion rules in step 510, the presence server receives a response from the wireless communication device (step 512) and sends the response to the caller according to the set of message conversion rules (step 514). Subsequent to sending the response to the caller according to the message conversion rule set in step 514, the presence server determines whether the call connection is still established (step 516). If the call connection is terminated, no output of step 516, then the process terminates thereafter. If the call connection is still established, yes output of step 516, then the process returns to step 508.

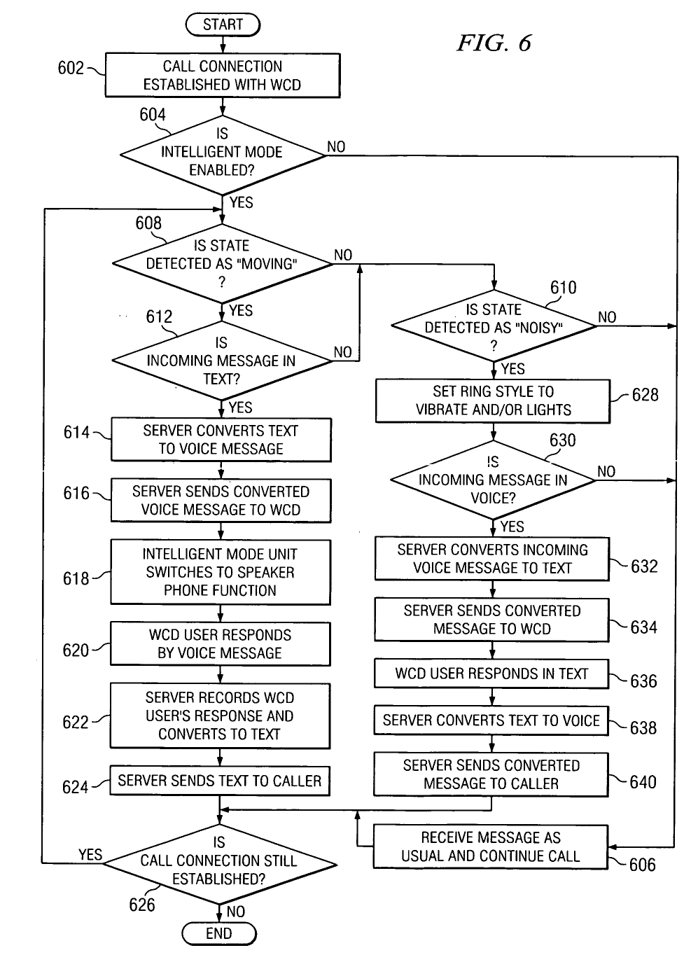

With reference now to FIG. 6, a flowchart is depicted illustrating an exemplary process for presence and ambient noise detection in a wireless communication device in accordance with an embodiment of the present invention. The process depicted in FIG. 6 may be implemented, for example, in a wireless communication device, such as client wireless communication device 400 in FIGS. 4A and 4B.

The process begins when a presence server, such as presence server 12U in FIG. 1, establishes a call connection to a wireless communication device, such as wireless communication device 140 in FIG. 1 (step 602). The wireless communication device then makes a determination as to whether a user enabled the wireless communication device intelligent mode unit, such as, for example, intelligent mode unit 430 in FIG. 4 (step 604). If the intelligent mode unit is not enabled, no output of step 604, then the wireless communication device receives and responds to the incoming messages as usual under normal operation (step 606). The process proceeds to step 626 thereafter.

If the intelligent mode unit is enabled, yes output of step 604, then the wireless communication device determines whether the wireless communication device state is detected as “moving” (step 608). If the state is not detected as “moving,” no output of step 608, then the process proceeds to step 610. If the state is detected as “moving,” yes output of step 608, then the wireless communication device makes a determination as to whether the caller's incoming message is in text (step 612). If the caller's incoming message is not in text, no output of step 612, then the process returns to step 610. If the caller's incoming message is in text, yes output of step 612, then the presence server employs a text-to-voice converter, such as text-to-voice converter 308 in FIG. 3, to convert the incoming text message into a voice message (step 614).

In another embodiment of the present invention, message conversion may occur in the wireless communication device itself. Conversion of the text message into a voice message may allow the moving wireless communication device user to receive the message without diverting the user's attention away from an activity. For example, a driver of a moving vehicle that was sent a text message does not have to stop watching traffic to read the text message because the text message was converted into a voice message by an embodiment of the present invention.

After the presence server converts the incoming text message into a voice message in step 614, the presence server sends the converted message to the wireless communication device (step 616). In addition, the presence server also may send the original text message for display on the wireless communication device display screen, such as display 406 on client wireless communication device 400 in FIG. 4. Subsequent to receiving the converted message that the presence server sent in step 616, the wireless communication device intelligent mode unit enables a speaker phone function, which allows the converted message to output over a speaker, such as speaker 414 in FIG. 4 (step 618). By enabling the speaker function, the intelligent mode allows the user of the moving wireless communication device to continue to use the user's hands for other activities, such as driving.

The user of the wireless communication device responds to the incoming converted message by voice (step 620). By responding to the incoming converted message by voice, the user of the wireless communication device is spared the task of keying in a responding text message on a keypad, such as keypad 408 in FIG. 4. Thus, the user of the moving wireless communication device may respond to incoming text messages without diverting the user's attention away from other activities, such as driving once again.

The presence server records or buffers the wireless communication device user's voice response in order to convert the user's voice response into a text message (step 622). The presence server uses a voice recognition system, such as voice recognition system 310 in FIG. 3, to convert the user's voice response into text. Subsequent to converting the user's voice response into text in step 622, the presence server sends the converted response message to the caller (step 624).

After sending the converted response message to the caller in step 624, the presence server makes a determination as to whether the call connection is still established (step 626). If the call connection is terminated, no output of step 626, then the process terminates thereafter. If the call connection is still established, yes output of step 626, then the process returns to step 608.

Returning again to step 610, the presence server determines if the wireless communication device state is detected as “noisy” (step 610). If the wireless communication device state is not detected as “noisy,” no output of step 610, then the process returns to step 606 where the wireless communication device receives the message as usual during normal operation. If the wireless communication device state is detected as “noisy,” yes output of step 610, then the intelligent mode unit automatically sets the ring style to vibrate and/or lights (step 628).

Because the wireless communication device state is detected as “noisy,” automatically changing the ring style to vibrate and/or lights may make the user of the wireless communication device aware that a message is incoming in a loud environment. For example, a person in a crowded, noisy football stadium during a game may not hear a normal ring tone, even if set to loud. Consequently, the intelligent mode unit by automatically setting the ring style to vibrate and/or lights affords the user of the wireless communication device a greater opportunity to receive the incoming message in such an environment.

After the ring style is automatically set to vibrate and/or ring in step 628, the presence server determines whether the incoming message is in voice (step 630). If the incoming message is not in voice, no output of step 630, then the process returns to step 606 where the message is received as usual. If the incoming message is in voice, yes output of step 630, then the presence server automatically converts the incoming voice message into text (step 632). By automatically converting the incoming voice message into text, the presence server allows the user of the client wireless communication device to read the message instead of trying to hear the voice message in a noisy environment, such as a football game.

Subsequent to converting the incoming voice message into text in step 632, the presence server sends the converted message to the wireless communication device (step 634). After receiving the converted incoming message in step 634, the wireless communication device user responds in text (step 636). The user responds by text message because of the noisy environment. The noisy environment may prevent the caller from hearing what the user of the wireless communication device is saying. Alternatively, in another embodiment of the present invention the user may respond to the incoming text message by voice using a background noise filtering system enabled by the ambient noise detector during levels of high ambient noise.

Subsequent to the user responding to the incoming converted message by text message in step 636, the presence server automatically converts the user's text message into a voice message (step 638). After converting the user's text message into a voice message in step 638, the presence server sends the converted response message to the caller (step 640). The process returns to step 626 thereafter.

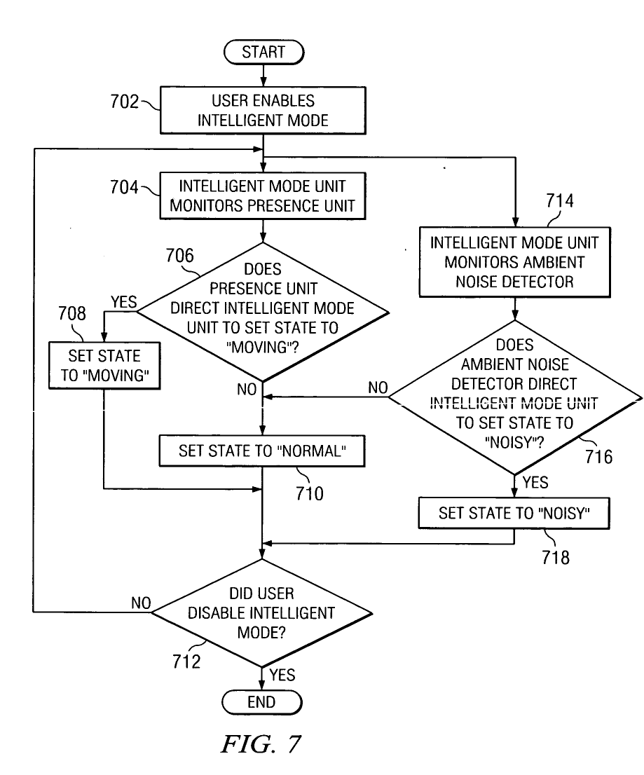

Referring now to FIG. 7, a flowchart is depicted illustrating an exemplary process for automatically setting states in a wireless communication device using an intelligent mode unit in accordance with an embodiment of the present invention. The process depicted in FIG. 7 may be implemented, for example, in an intelligent mode unit contained within a wireless communication device, such as intelligent mode unit 430 contained within wireless communication device 400 in FIG. 4.

The process begins when a user enables the wireless communication device intelligent mode unit (step 702). Subsequent to the user enabling the intelligent mode unit, the intelligent mode unit monitors a presence unit, such as presence unit 440 in FIG. 4, for presence information with regard to movement of the wireless communication device (step 704). While monitoring the presence unit in step 704, the intelligent mode unit makes a determination as to whether the presence unit directs the intelligent mode unit to automatically set the wireless communication device state to “moving” (step 706). If the presence unit directs the intelligent mode unit to automatically set the state to “moving,” yes output of step 706, then the intelligent mode unit sets the state to “moving” (step 708). The process proceeds to step 712 thereafter. If the presence unit does not direct the intelligent mode unit to automatically set the state to moving, no output of step 706, then the intelligent mode unit automatically sets the wireless communication device state to “normal,” which may be, for example, a default setting for the intelligent mode unit.

After automatically setting the wireless communication device state to “normal,” the intelligent mode unit determines whether the user disables the intelligent mode unit (step 712). If the user disables the intelligent mode unit, yes output of step 712, then the process terminates thereafter. If the user does not disable the intelligent mode unit, no output of step 712, then the process returns to step 704.

Concurrent with step 704, the intelligent mode unit monitors an ambient noise detector, such as ambient noise detector 444 in FIG. 4, for ambient noise levels surrounding the wireless communication device (step 714). While monitoring the ambient noise detector in step 714, the intelligent mode unit determines whether the ambient noise detector directs the intelligent mode unit to automatically set the wireless communication device state to “noisy” (step 716). If the ambient noise detector directs the intelligent mode unit to automatically set the state to “noisy,” yes output of step 716, then the intelligent mode unit sets the state to “noisy” (step 718). The process returns to step 712 thereafter. If the ambient noise detector does not direct the intelligent mode unit to automatically set the state to “noisy,” no output of step 716, then the process returns to step 710 where the intelligent mode unit sets the state to “normal.”

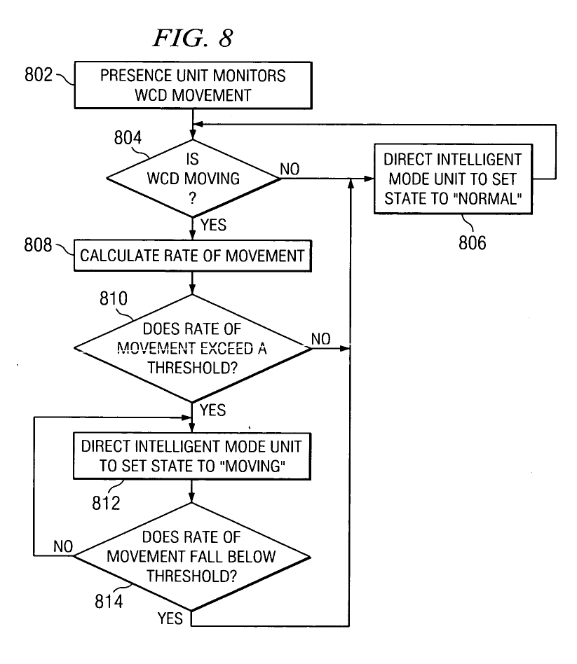

Turning now to FIG. 8, a flowchart is depicted illustrating an exemplary process for determining presence in a wireless communication device using a presence unit in accordance with an embodiment of the present invention. The process depicted in FIG. 8 may be implemented, for example, in a presence unit contained within a wireless communication device, such as presence unit 440 contained within wireless communication device 400 in FIG. 4.

In an embodiment of the present invention the presence unit continuously monitors the wireless communication device for presence or movement (step 802). In another embodiment of the present invention, the wireless communication device user may enable and disable the presence unit as the user enables and disables an intelligent mode unit, such as intelligent mode unit 430 in FIG. 4. In a further embodiment of the present invention, the user may enable and disable the presence unit independently of other wireless communication device functions.

While the presence unit monitors the wireless communication device for movement in step 802, the presence unit makes a determination as to whether the wireless communication device is moving (step 804). The presence unit may determine if the wireless communication device is moving by, for example, monitoring cell tower log information stored in memory, such as main memory 424 in FIG. 4. The presence unit may create the cell tower log by, for example, continuously transmitting a signal to cell towers and receiving back a signal from each cell tower as to the cell tower's location and time of transmission. This exemplary cell tower information may be stored in the log for continuous referencing by the presence unit. The presence unit may use the referenced cell tower log information, such as the location of each specific cell tower and the time each specific cell tower was signaled by the wireless communication device, to calculate motion vectors. A motion vector is simply a direction of movement over a period of time, which may be determined by the cell tower log in this example.

Alternatively, the presence unit may monitor the cellular telephone service provider cell tower logs stored within a storage unit, such as storage unit 170 in FIG. 1, in order to determine motion vectors. Or, the presence unit may monitor a cell tower log database located within a presence server, such as cell tower log database 312 located within presence server 300 in FIG. 3, to determine motion vectors. Or, the presence unit may, for example, monitor a global positioning system unit, such as global positioning system unit 442 in FIG. 4, for position and time information with regard to the wireless communication device in order to determine motion vectors. In addition, global positioning information from the wireless communication device may be stored, for example, in a global positioning system tracking unit contained within the presence server, such as wireless communication device global positioning system tracking unit 314 contained within presence server 300 in FIG. 3.

If the presence unit determines that the wireless communication device is not moving, no output of step 804, then the presence unit directs the intelligent mode unit to automatically set the wireless communication device state to “normal” (step 806). The process returns to step 804 thereafter. If the presence unit determines that the wireless communication device is moving, yes output of step 804, then the presence unit calculates the rate of movement of the wireless communication device (step 808). The presence unit calculates the wireless communication device rate of movement by dividing the distance traveled by the wireless communication device by the time required to travel that distance. The distance traveled and time period required for the calculation are determined by, for example, the cell tower logs and/or the global positioning system information discussed above.

Subsequent to the presence unit calculating the wireless communication device rate of movement in step 808, the presence server determines whether the rate of movement exceeds a predetermined threshold (step 810). The predetermined threshold may be set, for example, at 5 miles per hour. However, it should be noted that embodiments of the present invention are not restricted to the above mentioned threshold example. Embodiments of the present invention may utilize any distance over time measurement as a threshold. Furthermore, an embodiment of the present invention may employ multiple thresholds, such as, for example, a threshold for walking, a threshold for running, a threshold bicycling, and a threshold for driving. In addition, the predetermined threshold may be set by, for example, a user of the client wireless communication device, an administrator of the presence server, or an administrator of the cellular telephone service provider. Further, an application located within the presence server, such as application 316 located within presence server 300 in FIG. 3, may use a default threshold setting.

If the rate of movement does not exceed the threshold, no output of step 810, then the process returns to step 806 where the presence unit directs the intelligent mode unit to automatically set the wireless communication device state to “normal.” If the rate of movement does exceed the threshold, yes output of step 810, then the presence unit directs the intelligent mode unit to automatically set the wireless communication device state to “moving” (step 812).

After the presence unit directs the intelligent mode unit to automatically set the state to “moving,” the presence unit makes a determination as to whether the rate of movement falls below the threshold (step 814). If the rate of movement of the wireless communication device falls below the threshold, yes output of step 814, then the process returns to step 806. If the wireless communication device rate of movement does not fall below the threshold, no output of step 814, then the process returns to step 812.

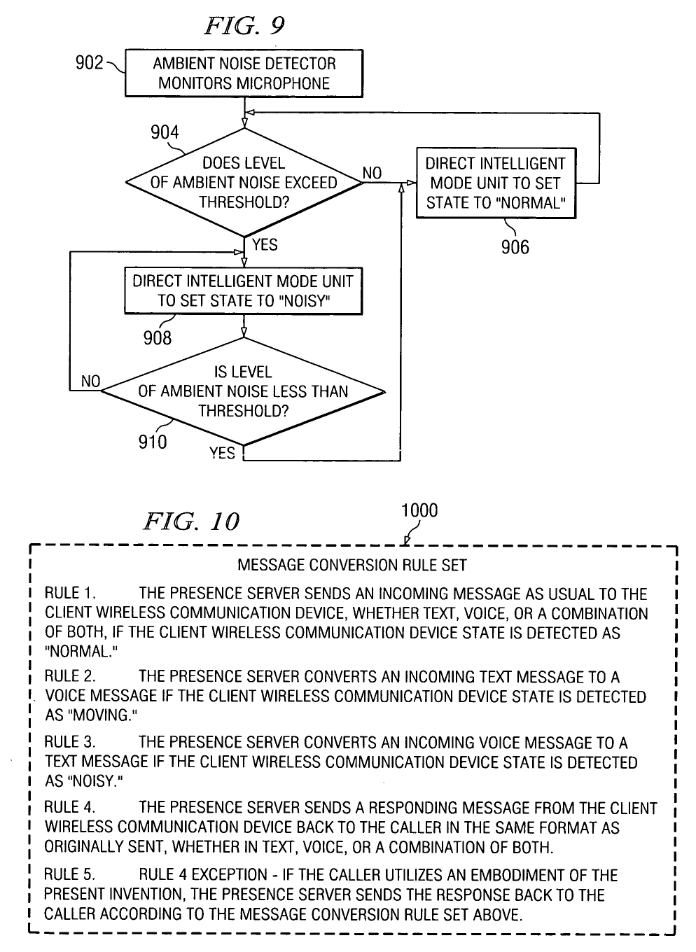

With reference now to FIG. 9, a flowchart is depicted illustrating an exemplary process for determining ambient noise levels surrounding a wireless communication device using an ambient noise detector in accordance with an embodiment of the present invention. The process depicted in FIG. 9 may be implemented, for example, in an ambient noise detector contained within a wireless communication device, such as ambient noise detector 444 contained within wireless communication device 400 in FIG. 4.

In an embodiment of the present invention, the ambient noise detector continuously monitors ambient noise levels surrounding the wireless communication device by using the wireless communication device's microphone, such as microphone 416 in FIG. 4 (step 902). In another embodiment of the present invention, the ambient noise detector only monitors ambient noise levels surrounding the wireless communication device when, for example, the wireless communication device detects an incoming message or call. In a further embodiment of the present invention, the user of the wireless communication device may enable and disable the ambient noise detector when the user enables and disables an intelligent mode unit, such as intelligent mode unit 430 in FIG. 4. In a further embodiment of the present invention, the user may enable and disable the ambient noise detector independently of other wireless communication device functions.

While the ambient noise detector monitors the wireless communication device's surrounding ambient noise level in step 902, the ambient noise detector makes a determination as to whether the level of ambient noise exceeds a predetermined threshold (step 904). The predetermined threshold may be set, for example, at any decibel level. However, it should be noted that embodiments of the present invention are not restricted to the above mentioned decibel level threshold example. Embodiments of the present invention may utilize any noise or sound measurement as a threshold. In addition, the predetermined threshold may be set by, for example, a user of the client wireless communication device. Further, if the user does not set an ambient noise level threshold, then the ambient noise detector may use, for example, a default threshold setting.

If the level of ambient noise surrounding the wireless communication device does not exceed the threshold, no output of step 904, then the ambient noise detector directs the intelligent mode unit to automatically set the wireless communication device state to “normal” (step 906). The process returns to step 904 thereafter. If the level of ambient noise surrounding the wireless communication device does exceed the threshold, yes output of step 904, then the ambient noise detector directs the intelligent mode unit to automatically set the wireless communication device state to “noisy” (step 908).

After the ambient noise detector directs the intelligent mode unit to automatically set the wireless communication device state to “noisy” in step 908, then the ambient noise detector makes a determination as to whether the level of ambient noise level is less than the threshold (step 910). If the level of ambient noise level surrounding the wireless communication device is less than the threshold, yes output of step 910, then the process returns to step 906. If the level of ambient noise level surrounding the wireless communication device is not less than the threshold, no output of step 910, then the process returns to step 908.

Referring now to FIG. 10, an exemplary set of rules for message conversion in a presence server is shown in accordance with embodiments of the present invention. The presence server may store the message conversion rule set in a rules database contained within the presence server. For example, presence server 300 stores the message conversion rule set in rules database 304 in FIG. 3.

Message conversion rule set 1000 is only presented as an example of a set of rules for message conversion in a presence server by embodiments of the present invention. Embodiments of the present invention are not restricted to the use of message conversion rule set 1000. Any set of rules for message conversion may be utilized by embodiments of the present invention that are capable of accomplishing the message conversion function. An illustrative rule contained within message conversion rule set 1000 may be, for example, Rule 4, which states that a caller receives a responding message from the wireless communication device back in the same format as originally sent by the caller, whether in text, voice, or a combination of both.

Thus, embodiments of the present invention provide a computer implemented method, apparatus, and computer usable program code for automatic presence and ambient noise detection for a wireless communication device. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method in a network data processing system for automatic presence and ambient noise detection for a client device, the computer implemented method comprising:
receiving an incoming message from a caller;
responsive to receiving the incoming message from the caller, detecting a client device state based on a callee situation as dynamically detected by using the client device;
responsive to detecting the client device state, converting the incoming message according to a rule set to form a converted incoming message; and
rendering the converted incoming message on the client device, wherein the converted incoming message is rendered differently than the incoming message would have been by the client device.

2. The computer implemented method of claim 1, further comprising:
receiving a response message from the client device;
responsive to receiving the response message from the client device, converting the response message according to the rule set to form a converted response message; and
sending the converted response message to the caller.

3. The computer implemented method of claim 1, wherein the client device is a wireless communication device, and wherein the wireless communication device is one of a cellular telephone, a personal digital assistant, a handheld computer, and a laptop computer.

4. The computer implemented method of claim 2, wherein the steps are implemented in a server, and wherein the server is a presence server.

5. The computer implemented method of claim 4, wherein the presence server is located within a cellular telephone service provider network.

6. The computer implemented method of claim 4, wherein the presence server is in communication with a plurality of client devices.

7. The computer implemented method of claim 1, wherein the rule set is a message conversion rule set, and wherein the message conversion rule set is contained within a database.

8. The computer implemented method of claim 1, wherein converting the incoming message includes at least one of text-to-voice and voice-to-text conversion.

9. The computer implemented method of claim 1, wherein the converting step occurs at the client device.

10. The computer implemented method of claim 1, wherein the client device includes at least one of an intelligent mode unit, a presence unit, and an ambient noise detector.

11. The computer implemented method of claim 1, wherein the client device state is detected as at least one of normal, moving, and noisy.

12. The computer implemented method of claim 11, wherein an intelligent mode unit contained within the client device enables a speaker phone function when the client device state is detected as moving.

13. The computer implemented method of claim 11, wherein an intelligent mode unit sets a ring style to at least one of vibrate and lights when the client device state is detected as noisy.

14. The computer implemented method of claim 11, wherein the converted incoming message includes converting an incoming text message into a voice message when the client device state is detected as moving.

15. The computer implemented method of claim 11, wherein the converted incoming message includes converting an incoming voice message into a text message when the client device state is detected as noisy.

16. The computer implemented method of claim 2, wherein converting the response message includes converting the response message back to a same format as the incoming message from the caller.

17. A data processing system comprising:
a bus system;
a storage device connected to the bus system, wherein the storage device includes a set of instructions; and
a processing unit connected to the bus system, wherein the processing unit executes the set of instructions to receive an incoming message from a caller, detect a client device state based on a callee situation as dynamically detected by using the client device in response to receiving the incoming message from the caller, convert the incoming message according to a rule set to form a converted incoming message in response to detecting the client device state, and render the converted incoming message on the client device, wherein the converted incoming message is rendered differently than the incoming message would have been by the client device.

18. A computer program product for automatic presence and ambient noise detection for a wireless communication device, the computer program product comprising:
a computer usable medium having computer usable program code embodied therein, the computer usable medium comprising:
computer usable program code configured to receive an incoming message from a caller;
computer usable program code configured to detect a client device state based on a callee situation as dynamically detected by using the client device in response to receiving the incoming message from the caller;
computer usable program code configured to convert the incoming message according to a rule set to form a converted incoming message in response to detecting the client device state; and
computer usable program code configured to render the converted incoming message on the client device, wherein the converted incoming message is rendered differently than the incoming message would have been by the client device.

19. The computer program product of claim 18, further comprising:
computer usable program code configured to receive a response message from the client device;
computer usable program code configured to convert the response message according to the rule set to form a converted response message in response to receiving the response message from the client device; and
computer usable program code configured to send the converted response message to the caller.

20. The computer program product of claim 19, wherein converting the response message includes converting the response message back to a same format as the incoming message from the caller.
